(19) United States
(12) Patent Application Publication
(10) Pub. No.: US 2005/0272879 A1
(43) Pub. Date: Dec. 8, 2005

(54) Resin with excellent processability for lightguide plate

(75) Inventors: Osamu Kawai, Hiroshima (JP); Satoshi Onda, Kanagawa (JP); Hiroki Hatakeyama, Hiroshima (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Rayon Co., Ltd., Tokyo (JP)

(21) Appl. No.: 10/531,467

(22) PCT Filed: Oct. 16, 2003
(86) PCT No.: PCT/JP03/13252

§ 371 Date: Apr. 15, 2005

(30) Foreign Application Priority Data
Oct. 22, 2002 (JP) 2002-306767

(51) Int. Cl. C08L 33/00

(52) U.S. Cl. 525/418

(57) ABSTRACT

This invention provides a resin for light guiding plates which retains physical properties as acrylic resins such as transparency and exhibits good processability with minimum scorching of an edge during polishing or cutting. This resin for light guiding plates is made of a polymer prepared by polymerizing a mixture comprising 100 parts by weight of a polymerizable material consisting of 91 to 100% by weight of methyl methacrylate and 0 to 9% by weight of a monofunctional acrylate, and 0.01 to 2 parts by weight of a polyfunctional (meth)acrylate. The resin preferably comprises 0.01 to 1000 ppm of a diffusing agent.

### TECHNICAL FIELD

This invention relates to a resin for light guiding plates with improved processability such as cutting and edge polishing.

### BACKGROUND ART

Light guiding plates have been extensively used as a component of a back light in a liquid-crystal display (See, Japanese Laid-open Patent Publication No. 4-145485). The light guiding plates are used such that a light from a source such a cold-cathode tube enters the light guiding plate through its edge and exits in a direction of the light guiding plate plane. The light guiding plates are made of an acrylic resin having a higher light transmittance. When forming a light guiding plate from an acrylic resin plate, the resin plate is cut pieces with a predetermined size, the edge of which is then polished by a grinder such a diamond bite and used as a plane of light incidence. In cutting a resin plate or polishing an edge by a grinder as described above, there have been problems of reduction of a life of a blade for polishing and an inadequate operation speed, due to scorching of the resin. There have been no studies for improving a resin plate, focusing improvement in its processability.

### DISCLOSURE OF THE INVENTION

An objective of this invention is to provide a resin for light guiding plates which retains physical properties as an acrylic resin such as transparency and exhibits good processability with minimum scorching of an edge during polishing or cutting.

After keen investigation to achieve the objective, we have found that the objective can be achieved by introducing a particular amount of a crosslinking structure into an acrylic resin having a particular composition, resulting in this invention.

This invention relates to a resin for light guiding plates made of a polymer prepared by polymerizing a mixture comprising a polymerizable material consisting of methyl methacrylate alone or methyl methacrylate and a monofunctional acrylate, and a polyfunctional (meth)acrylate, wherein the content of the monofunctional acrylate in the polymerizable material is 9% by weight or less and the content of the polyfunctional (meth)acrylate in the mixture is 0.01 to 2 parts per 100 parts by weight of the polymerizable material.

A resin for light guiding plates according to this invention retains higher transparency, mechanical properties and printing properties as an acrylic resin, while exhibiting significantly improved processability such as cutting and polishing, and is suitable for light guiding plates, in which an edge to be a light entrance is cut and polished and in whose rear face is printed a dot pattern for adjusting an outgoing beam.

### BEST MODE FOR CARRYING OUT THE INVENTION

For maintaining good transparency, heat resistance and mechanical properties as an acrylic resin, a resin for light guiding plates according to this invention is made of a polymer prepared by polymerizing a polymerizable mixture comprising a polymerizable material consisting of 91 to 100% by weight of methyl methacrylate and 0 to 9% by weight of a monofunctional acrylate, and 0.01 to 2 parts by weight of a polyfunctional (meth)acrylate per 100 parts by weight of the polymerizable material.

In a resin for light guiding plates according to this invention, a monofunctional acrylate may be copolymerized in order to improve adhesion between a resin and an ink in a process for printing a dot pattern for improving evenness of an outgoing beam in a step of manufacturing a light guiding plate and to reduce the amount of unpolymerized monomers during producing a plate by polymerization. A monofunctional acrylate used which can be used is preferably a monofunctional acrylate having a hydrocarbon group with 1 to 9 carbon atoms; for example, methyl acrylate, ethyl acrylate, butyl acrylate, isobutyl acrylate, t-butyl acrylate and 2-ethylhexyl acrylate. Among these, a monofunctional acrylate having a hydrocarbon group with up to 4 carbons is preferable because a resin prepared therefrom may have a less-reduced glass transition temperature and good cutting processability. Butyl acrylate is particularly preferable because of its low toxicity.

A content of the monofunctional acrylate in a polymerizable material is 9% by weight or less. When the content is 9% by weight or less, a glass transition temperature of the molecular structure is not significantly reduced and thus scorching can be avoided, resulting in good cutting processability. The content is preferably 7% by weight. When it is desired to reduce a residual monomer amount in a polymer, the monofunctional acrylate is preferably contained at 0.1% by weight or more in the polymerizable material. In the light of good cut processability and reduction in a residual monomer amount, the most preferable content of the monofunctional acrylate is 1.5% by weight to 5% by weight.

Methyl methacrylate is contained at 91% by weight or more, preferably 93% by weight or more in the polymerizable material. The upper limit of the content is preferably 99.9% by weight. Whereas the most preferable content of the above monofunctional acrylate is 1.5% by weight to 5% by weight both inclusive, a content of methyl methacrylate may be 95% by weight to 98.5% by weight.

A resin for light guiding plates according to this invention essentially has a crosslinking structure for improving processability and thus, for having such a crosslinking structure, consists of a polymer prepared by polymerizing a mixture of a polyfunctional (meth)acrylate and the above polymerizable material. Preferable examples of a polyfunctional (meth)acrylate include ethyleneglycol di(meth)acrylate, propyleneglycol di(meth)acrylate, 1,4-butanediol di(meth)acrylate, 1,6-hexanediol di(meth)acrylate and neopentylglycol di(meth)acrylate. The term, “(meth)acryl” as used herein refers to “acryl” and “methacryl”. A content of the polyfunctional (meth)acrylate constituting a crosslinking structure is 0.01 to 2 parts by weight per 100 parts by weight of methyl methacrylate alone or the polymerizable material consisting of methyl methacrylate and a monofunctional acrylate. When the content is 0.01 parts by weight or more, processability can be improved and when it is 2 parts by weight or less, cracks during cutting may be avoided and thus apparent defects in the step of manufacturing a plate may be avoided, resulting in good printing properties. Its lower limit is preferably 0.05 parts by weight while its upper limit is preferably 1 part by weight.

A resin for light guiding plates according to this invention may comprise a diffusing agent for improving an outgoing efficiency of an incident light. Examples of a diffusing agent include inorganic particles such as titanium dioxide, silica, barium sulfate and calcium carbonate; and organic cross-linked particles such as methacrylic resins, polystyrene resins and silicon resins. These diffusing agents may be used in combination of two or more.

An average particle size of a diffusing agent is preferably within the range of 0.1 to 20 μm. If the average particle size is too small, a light may be scattered, leading to an yellowish outgoing light. If the average particle size is too large, an outgoing light may become significantly uneven.

A content of the diffusing agent is preferably 0.01 to 1000 ppm (parts per million by weight) in a resin for light guiding plates. Its lower limit is more preferably 0.05 ppm while its upper limit is preferably 100 ppm. A content of 0.01 ppm or more, an outgoing efficiency may be effectively increased. If it is 1000 ppm or less, the diffusing agent can be adequately dispersed.

A resin for light guiding plates according to this invention may be, if necessary, additives such as an ultraviolet absorber and a photostabilizer.

A resin for light guiding plates according to this invention is preferably formed as a plate by polymerizing the above polymerizable mixture by means of heat or light in a mold.

The above polymerizable mixture in this invention may contain, in addition to methyl methacrylate, a polyfunctional (meth)acrylate and, an optional monofunctional acrylate, additional components as long as desired properties for a light guiding plate can be obtained. The polymerizable mixture preferably contains a polymerization initiator in the light of smoothly performing a polymerization reaction, and may further contain additives such as a diffusing agent, a mold release agent, an ultraviolet absorber and a photostabilizer as necessary.

The polymerizable mixture may contain a homopolymer of methyl methacrylate or a copolymer of methyl methacrylate and a monofunctional acrylate or polyfunctional (meth)acrylate. Alternatively, the polymerizable mixture may be a syrup consisting of a polymer and monomers prepared by partially pre-polymerizing the polymerizable mixture. In these cases, a content of the polymer in the polymerizable mixture is preferably such that a content of monomer components in a structural polymer unit meets the above content range in terms of the polymerizable mixture.

In this invention, the total amount of the polymerizable material consisting of methyl methacrylate alone or methyl methacrylate and a monofunctional acrylate, and a polyfunctional (meth)acrylate is preferably 90% by weight or more, more preferably 95% by weight or more in the polymerizable mixture, in the light of desired properties of a resin for light guiding plates. However, when the mixture contains the homopolymer of methyl methacrylate or the copolymer of methyl methacrylate with a monofunctional acrylate or polyfunctional (meth)acrylate, the total amount of the polymerizable material consisting of methyl methacrylate alone or methyl methacrylate and the monofunctional acrylate, the polyfunctional (meth)acrylate, and the homopolymer of methyl methacrylate or the copolymer of methyl methacrylate with the monofunctional acrylate or the polyfunctional (meth)acrylate is preferably 90% by weight or more, more preferably 95% by weight or more in the polymerizable mixture. In this case, the amount of the homopolymer of methyl methacrylate or the copolymer of methyl methacrylate with the monofunctional acrylate or the polyfunctional (meth)acrylate is preferably 40% by weight or less, more preferably 30% by weight or less in the polymerizable mixture.

Examples of a polymerization initiator include azo-based initiators; peroxide-based thermal-polymerization initiators; and photoinitiators such as benzoin ethers, acylphosphine oxides and acetophenones, which are commonly used. These may be used alone or in combination of two or more for polymerization.

A mold used in polymerization may be selected from those manufactured by sandwiching a gasket made of, for example, a soft polyvinyl chloride, an ethylene-vinyl acetate copolymer, polyethylene or an ethylene-methyl methacrylate copolymer between two glass or stainless plates and fixing it by a clamp, and those consisting of two parallel stainless endless belts facing to each other and a gasket.

### EXAMPLES

This invention will be more specifically described with reference to, but not limited to, examples. In these examples, evaluations were conducted as follows.

1) Whole Light Transmittance and Haze

They were determined using a haze meter NDH 2000 from Nippon Denshoku Industries Co., Ltd. in accordance with JIS K 7105.

2) Cutting Properties

A sample was cut at a blade rotating speed of 1200 rpm and a feeding rate of 300 mm/min using an NC milling cutter AE 64 from Sakazaki Machinery Co. Ltd. equipped with a super-hard straight router bit (two blades) with a diameter of 6 mm from Kanefusa Corporation, and scorching in a resin was visually observed.

◯: No scorching

Δ: Slight scorching in a resin

X: Significant scorching in a resin

3) Printing Properties

Screen printing was conducted using Ink #2500 from Seiko Advance ltd. After drying at 60° C. for 30 min, the sample was subjected to a lattice-pattern peeling test. Lattice-pattern peeling test:

A sample was notched in 11×11 lines with a pitch of 1 mm by a razor to make 100 lattice grids. After tightly attaching a cellophane tape on the sample, the tape was quickly detached by pulling it in a vertical direction and the grids in which the applied film remained were counted. The sample was evaluated in accordance with the following criteria.

◯: No peeling

Δ: Peeling in 50% or less of grids

X: Peeling in over 50% of grids

### Example 1

To a reactor equipped with a reflux condenser, a thermometer and a stirrer were placed 96 parts by weight of methyl methacrylate and 4 parts by weight of n-butyl acrylate. After adding 0.063 parts by weight of n-dodecyl mercaptan as a molecular-weight adjusting agent, the mixture was heated to an internal temperature of 80° C. with stirring and 0.05 parts by weight of 2,2′-azobis-(2,4-dimethylvaleronitrile) as a polymerization initiator was added to the mixture. The mixture was further heated to an internal temperature of 90° C. and maintained at the temperature for 13 min. Then, the mixture was cooled to room temperature to give a syrup with a polymerization rate of about 26% by weight and a viscosity of 2 Pa·s at 20° C. Then, to 100 parts by weight of the syrup were added 0.15 parts by weight of ethyleneglycol dimethacrylate, 0.00005 parts by weight (corresponding to 0.5 ppm in a resin plate prepared) of titanium dioxide with an average particle size of 0.2 μm, 0.13 parts by weight of t-hexyl peroxypivalate, 0.005 parts by weight of sodium di(2-ethylhexyl) sulfosuccinate and 0.01 parts by weight of 2-(2H-benzotriazol-2-yl)-4-methylphenol. The mixture was stirred and then poured into a mold consisting of two plates of tempered glass facing to each other with a space of 6.4 mm via a polyvinyl chloride gasket. After immersing the mold in warm water at 78° C. for 30 min to initiate polymerization, it was heated in an air oven at 130° C. for 60 min. At the end of heating, it was allowed to be cooled at room temperature and the product was removed from the mold to give an acrylic resin plate with a thickness of about 5 mm. Table 1 shows the evaluation results of the resin plates obtained.

TABLE 1

| | | | | | | | Comp. | Comp. | Comp. |
|---|---|---|---|---|---|---|---|---|---|
| | Example. 1 | Example. 2 | Example. 3 | Example. 4 | Example. 5 | Example. 6 | Example. 1 | Example. 2 | Example. 3 |
| Monofunctional | BA | BA | BA | BA | BA | EHA | BA | BA | BA |
| acrylate | | | | | | | | | |
| Amount of a | 4 | 4 | 4 | 4 | 2 | 4 | 4 | 4 | 10 |
| monofunctional | | | | | | | | | |
| acrylate (wt %) | | | | | | | | | |
| Amount of | 0.15 | 0.30 | 0.50 | 0.99 | 0.15 | 0.30 | 0 | 5.0 | 0.15 |
| EDMA | | | | | | | | | |
| (wt part) | | | | | | | | | |
| Whole-light | 92 | 92 | 92 | 92 | 92 | 92 | 92 | 92 | 92 |
| transmittance | | | | | | | | | |
| (%) | | | | | | | | | |
| Haze | 0.2 | 0.2 | 0.2 | 0.2 | 0.2 | 0.2 | 0.2 | 0.2 | 0.2 |
| (%) | | | | | | | | | |
| Cutting | Δ | ◯ | ◯ | ◯ | ◯ | Δ | X | ◯ | X |
| properties | | | | | | | | | |
| Printing | ◯ | ◯ | ◯ | ◯ | ◯ | ◯ | ◯ | Δ | ◯ |
| properties | | | | | | | | | |

BA: n-Butyl acrylate
EHA: 2-Ethylhexyl acrylate
EDMA: Ethyleneglycol dimethacrylate

### Examples 2 to 6

An acrylic resin plate was prepared as described in Example 1, except that another monofunctional acrylate was used in a different amount (100 parts by weight in combination with methyl methacrylate) and the amount of ethyleneglycol dimethacrylate was changed. The evaluation results for the resin plate obtained are shown in Table 1.

### Comparative Example 1

An acrylic resin plate was prepared as described in Example 1, without ethyleneglycol dimethacrylate. The evaluation results for the resin plate obtained are shown in Table 1.

### Comparative Example 2

An acrylic resin plate was prepared as described in Example 1, except that 5 parts by weight of ethyleneglycol dimethacrylate was used. Apparent defects due to a sink during polymerization were observed in the resin plate obtained.

### Comparative Example 3

An acrylic resin plate was prepared as described in Example 1, except that 90 parts by weight of methyl methacrylate and 10 parts by weight of n-butyl acrylate were used.

1. A resin for light guiding plates made of a polymer prepared by polymerizing a mixture comprising a polymerizable material consisting of methyl methacrylate alone or methyl methacrylate and a monofunctional acrylate, and a polyfunctional (meth)acrylate, wherein
the content of the monofunctional acrylate in the polymerizable material is 9% by weight or less; and
the content of the polyfunctional (meth)acrylate in the mixture is 0.01 to 2 parts per 100 parts by weight of the polymerizable material.

2. The resin for light guiding plates as claimed in claim 1, further comprising a diffusing agent of 0.01 to 1000 ppm
